(19) United States
(12) Patent Application Publication
(10) Pub. No.: US 2016/0217477 A1
(43) Pub. Date: Jul. 28, 2016

(54) Method And System For Providing FBO Market Share Information

(71) Applicant: PASSUR Aerospace, Inc., Stamford, CT (US)

(72) Inventors: Gage Rindt, Stamford, CT (US); Ron Dunsky, Stamford, CT (US); James Barry, Stamford, CT (US)

(21) Appl. No.: 14/604,119

(22) Filed: Jan. 23, 2015

(51) Int. Cl. G06Q 30/02; B64F 1/36; G01C 21/34

(52) U.S. Cl. CPC G06Q 30/0201; G01C 21/3453; B64F 1/36

(57) ABSTRACT

A method including detecting, for each of a plurality of aircraft during a time period, a corresponding plurality of ground positions; generating, for each of the plurality of aircraft, a path based on the corresponding plurality of ground positions; comparing each of the plurality of paths to each of a plurality of bounding boxes, each of the plurality of bounding boxes denoting a perimeter of a corresponding one of a plurality of fixed base operators (“FBOs”); generating a record of an FBO visit for each crossing of one of the paths into one of the bounding boxes, the record including an identity of the aircraft corresponding to the one of the paths and an identity of the one of the FBOs corresponding to the one of the bounding boxes; and determining market share data for each of the plurality of FBOs during the time period.

### BACKGROUND

Fixed based operators (commonly referred to as FBOs) are businesses that operate on the premises of an airport and provide commercial services such as fueling, aircraft storage, maintenance, etc. FBOs compete with one another to attract aviation customers substantially similarly to the manner in which service stations compete to attract motorists as customers. To compete effectively, the operator of an FBO may wish to understand the market share of the FBO as compared to the market shares of competing FBOs.

### SUMMARY OF THE INVENTION

A method includes detecting, for each of a plurality of aircraft during a time period, a corresponding plurality of ground positions; generating, for each of the plurality of aircraft, a path based on the corresponding plurality of ground positions; comparing each of the plurality of paths to each of a plurality of bounding boxes, each of the plurality of bounding boxes denoting a perimeter of a corresponding one of a plurality of fixed base operators (“FBOs”); generating a record of an FBO visit for each crossing of one of the paths into one of the bounding boxes, the record including an identity of the aircraft corresponding to the one of the paths and an identity of the one of the FBOs corresponding to the one of the bounding boxes; and determining market share data for each of the plurality of FBOs during the time period.

A system includes a data capture arrangement receiving, for each of a plurality of aircraft during a time period, a corresponding plurality of ground positions. The system also includes a memory storing a set of instructions. The system also includes a processor executing the set of instructions to perform operations including generating, for each of the plurality of aircraft, a path based on the corresponding plurality of ground positions; comparing each of the plurality of paths to each of a plurality of bounding boxes, each of the plurality of bounding boxes denoting a perimeter of a corresponding one of a plurality of fixed base operators (“FBOs”); generating a record of an FBO visit for each crossing of one of the paths into one of the bounding boxes, the record including an identity of the aircraft corresponding to the one of the paths and an identity of the one of the FBOs corresponding to the one of the bounding boxes; and determining share data for each of the plurality of FBOs during the time period.

A non-transitory computer-readable storage medium stores a set of instructions that are executable by a processor. The instructions, when executed by the processor, cause the processor to perform operations including detecting, for each of a plurality of aircraft during a time period, a corresponding plurality of ground positions; generating, for each of the plurality of aircraft, a path based on the corresponding plurality of ground positions; comparing each of the plurality of paths to each of a plurality of bounding boxes, each of the plurality of bounding boxes denoting a perimeter of a corresponding one of a plurality of fixed base operators (“FBOs”); generating a record of an FBO visit for each crossing of one of the paths into one of the bounding boxes, the record including an identity of the aircraft corresponding to the one of the paths and an identity of the one of the FBOs corresponding to the one of the bounding boxes; and determining market share data for each of the plurality of FBOs during the time period.

### BRIEF DESCRIPTION OF THE DRAWINGS

FIG. 1 illustrates an exemplary airport at which FBO market share may be monitored by the exemplary embodiments.

FIG. 2 schematically illustrates a system for monitoring FBO market share at an airport such as the exemplary airport of FIG. 1.

FIG. 3 shows an exemplary method for monitoring FBO market share at an airport such as the exemplary airport of FIG. 1, described with reference to the exemplary system of FIG. 2.

### DETAILED DESCRIPTION

The exemplary embodiments may be further understood with reference to the following description and the related appended drawings, wherein like elements are provided with the same reference numerals. Specifically, the exemplary embodiments relate to methods and systems for providing market share information to airport fixed base operators, which are commonly referred to as FBOs.

FBOs are businesses that operate on the premises of an airport and provide commercial services such as fueling, aircraft storage, maintenance, etc. At general aviation airports, there may be multiple FBOs that compete with one another to provide these services to customers, which may be private aircraft operators or commercial aircraft operators. For example, a single general aviation airport may have three FBOs operating on the airport premises and competing to service the same customers. Further, even at airports where only one FBO operates, as may be common at larger commercial airports, that single FBO may compete with FBOs at nearby airports within the same region to draw customers.

As is the case with many consumer-facing businesses, because these prospective customers may be able to choose from among multiple FBOs, operators of each FBO must compete with other FBOs in the same region to draw customers. Such competition may take the form of better prices, enhanced services, discounts for repeat business, etc. To compete in this market, the operator of an FBO may wish to obtain information that may help it better understand its market share. This information may include customer data both for its own customers and for its competitors' customers. Customer data may include tail number, owner, operator, class of aircraft, etc. However, under current techniques, the only way to obtain this information is to assign an individual to watch and log aircraft that are engaging the services of various FBOs.

Multilateration is a navigation technique in which stations at known locations broadcast signals at known times. Each multilateration measurement consists of the measurement of the difference in distance between two such stations. However, the use of one measurement from two stations results in an infinite number of possible locations along a hyperbolic curve. To determine an exact location, a second measurement is taken from a different pair of locations. The second measurement produces a second curve. The intersection of the first curve with the second curve enables the determination of the exact location, which is termed a “fix”.

At some airports, surface multilateration systems are used to track the position of the various aircraft that may be on the ground at the airport at any given time. One such multilateration system is the FAA Airport Surface Detection Equipment, Model X (“ASDE-X”) system, which has been implemented at 35 of the largest airports in the United States in order to aid air traffic controllers in managing ground traffic. Another such system is the Surface Multilateration (“SMLAT”) system produced by PASSUR Aerospace of Stamford, Conn. Either of these systems, or another multilateration-based surface position tracking system, may produce a data feed including a set of data points; each data point may be a single position measurement for a single aircraft, including aircraft identifying data (e.g., tail number, owner, operator, etc.), time, and location. In an alternative embodiment, a different system, such as an Automatic Dependent Surveillance-Broadcast (“ADS-B”) system may provide a data feed.

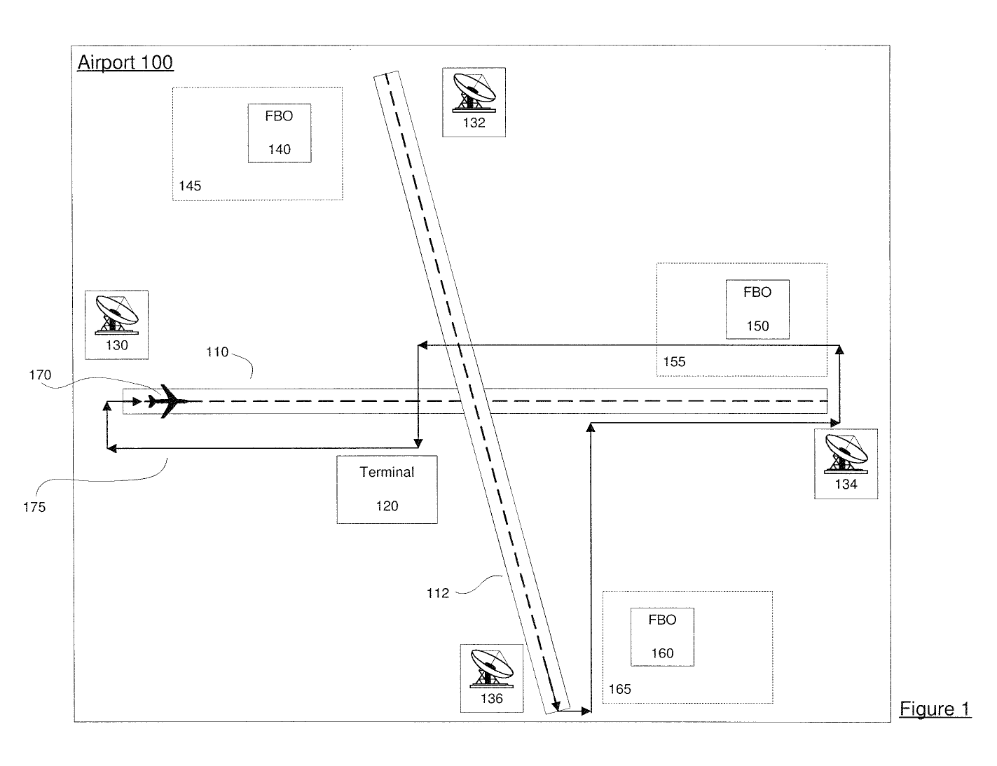

The exemplary embodiments use data generated by a multilateration system, or other ground-based location system, to generate market share data that may be useful to an FBO operator in marketing its services to prospective customers. FIG. 1 illustrates a layout of an exemplary airport 100. The airport 100 includes two runways 110 and 112 and a terminal 120. The airport 100 also includes sensor stations 130, 132, 134 and 136 that may enable tracking of positions of aircraft on the ground at the airport 100 according to the techniques described above. The airport 100 also includes three FBOs 140, 150 and 160 that each may provide services as described above, such as fueling, aircraft storage, maintenance, etc. It will be apparent to those of skill in the art that the specific quantities and locations of runways, sensor stations and FBOs shown for airport 100 in FIG. 1 are only exemplary, and that these and other details may differ in various real-world implementations.

The exemplary embodiments may operate through the use of a logical “bounding box” that is drawn around the locations of the FBOs 140, 150 and 160. Thus, the airport 100 may include bounding boxes 145, 155 and 165 drawn around FBOs 140, 150 and 160, respectively. It will be apparent to those of skill in the art that the bounding boxes 145, 155 and 165 are not objects that exist in the physical world, but, rather, are logical constructs for the purposes of data analysis. It will be further apparent to those of skill in the art that the sizes and shapes of the bounding boxes 145, 155 and 165 are only exemplary; any shape of enclosed two-dimensional perimeter may be used, and the size of each perimeter may be selected to accurately reflect the size of the premises of the corresponding FBO, or according to any other appropriate criteria.

The airport 100 also includes aircraft 170. It will be apparent to those of skill in the art that aircraft are not stationary and that the position of aircraft 170 will change over time, and that the position of aircraft 170 may only represent a snapshot of the airport 100 at a given point in time. It will be further apparent that additional aircraft beyond aircraft 170 may be present at airport 100 at different times; for clarity only a single aircraft 170 is shown. The aircraft 170 may travel along path 175 during its time at the airport 100. The path 175, indicated with an arrow denoting the end of each of a plurality of constituent segments, will be discussed in further detail below.

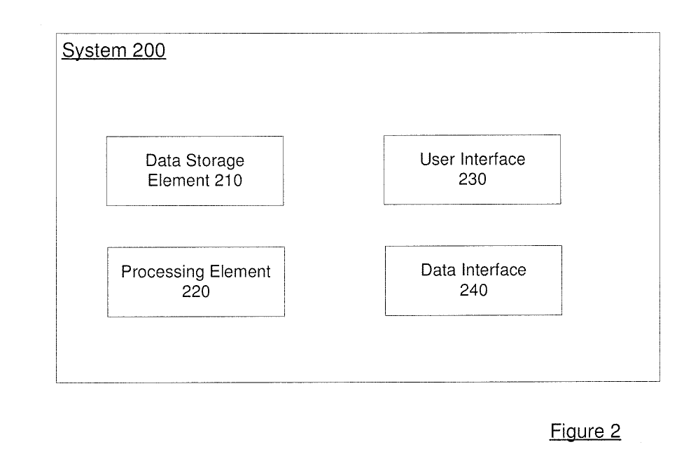

FIG. 2 illustrates an exemplary system 200. The system 200 may be a computing system including a combination of hardware and software. The system 200 includes a data storage element 210 (e.g., one or more hard drives, solid state drives, or other persistent data storage components). The data storage element 210 may store code for implementing the method 300, which will be described below. The computing system 200 also includes a processing element 220, which may include one or more microprocessors capable of executing code such as the code for implementing the method 300. The computing system 200 also includes a user interface 230, which may comprise one or more physical components (e.g., a keyboard, mouse, touchpad, display, touchscreen, etc.) operable to receive user inputs and provide results to a user. The computing system 200 also includes a data interface 240 providing for the receipt of data such as multilateration data captured by sensor stations 130, 132, 134 and 136. It will be apparent to those of skill in the art that there may be any number of possible implementations of a computing system 200, that such implementations may include additional elements not specifically described above, and that the computing system 200 may be capable of performing additional tasks beyond those described above with reference to the exemplary embodiments.

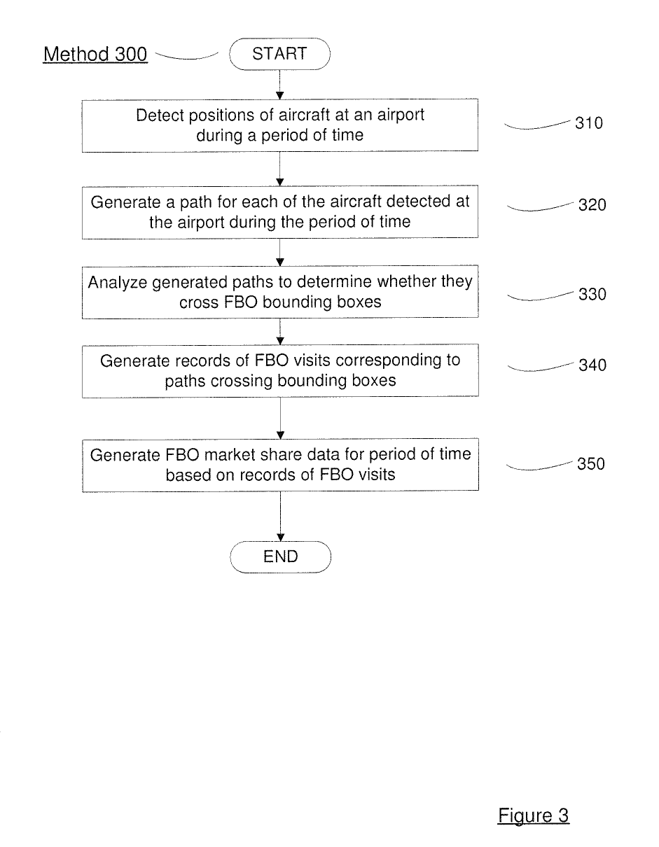

FIG. 3 illustrates an exemplary method 300. The method 300 will be described with specific reference to the exemplary airport, but it will be apparent to those of skill in the art that this is only exemplary. In step 310, positions of various aircraft at the airport 100 are tracked over a period of time. This tracking may be accomplished using the multilateration techniques described above (e.g., using distance measurements from sensor stations 130, 132, 134 and 136), or through any other suitable technique.

In step 320, path visualizations are generated for each aircraft that was present at airport 100 during the time period. Generation of each path from a plurality of its constituent location points may be accomplished using known interpolation or projection techniques. For example, path 175, shown in FIG. 1 with arrows denoting individual segments thereof, may be generated for aircraft 170, traveling from arrival on runway 112, through bounding box 155 denoting FBO 150, to terminal 120 and subsequently into position for departure on runway 110.

In step 330, paths are analyzed to determine whether a path crosses a bounding box denoting the location of an FBO; for example, considering the airport 100, one of the bounding boxes 145, 155 and 165 enclosing FBOs 140, 150 and 160, respectively. For example, the path 175 of aircraft 170 shown in FIG. 1 crosses bounding box 155. The time of performance for this analysis may vary among differing embodiments. In one embodiment, each aircraft may be analyzed individually on an ad hoc basis, such as when it departs from the airport 100. In another embodiment, paths may be analyzed periodically, such as daily, weekly, or monthly, with all paths recorded during the preceding time period analyzed at the end of the time period.

In step 340, the results of the path analysis of step 330 are evaluated to identify aircraft FBO visits. If a path crosses one of the bounding boxes, the aircraft represented by the path may be considered to have visited the FBO represented by the bounding box. Thus, continuing to consider the example shown in FIG. 1 and discussed with reference to step 330, aircraft 170 may be deemed to have visited FBO 150. Performance of this step may result in a record for an individual FBO visit. This record may include aircraft identifying data (for example, aircraft 100 may be identified using its aircraft class, manufacturer, owner, operator, tail number, or other identifying data), identity of the FBO visited (e.g., FBO 150), date and time of the visit (e.g., the time of recording of the first of the points comprising the path 175 to be located inside the bounding box 155), and duration of the visit (e.g., the time elapsed between the time of recording of the first of the points comprising the path 175 to be located inside the bounding box 155 and the time of recording of the last of the points comprising the path 175 to be located inside the bounding box 155). As was the case for step 320, this evaluation may be performed at different times, including at the time of each individual aircraft departure from the airport 100 or periodically, such as daily, weekly or monthly.

In step 350, the FBO visits identified in step 340 are aggregated over a period of time to produce market share data for the period of time. The period of time may be a calendar period (e.g., the week of December 7th to 13th of 2014, December 2014, the entire year of 2014, etc.), a relative interval (e.g., the week, month, or year immediately preceding the performance of step 340), or any other requested period of time. Additionally, performance of step 340 may be pre-scheduled (e.g., an operator of one of the FBOs 140, 150 and 160 may contract with an operator of system 200 for market share data to be provided for the preceding month at the end of each month) or on demand (e.g., an operator of one of the FBOs 140, 150 and 160 may request, from an operator of system 200, a single report of market share covering a specified time period). For example,

In addition to raw visit counts (e.g., during a given time period, 20 visits to FBO 140, 30 visits to FBO 150, 50 visits to FBO 160), the market share data produced in step 340 may include additional detail relating to the various individual aircraft comprising the market share of each of the FBOs. In one embodiment, the market share data may be capable of being filtered (e.g., by aircraft class, by time of day, etc.). In another embodiment, the market share data may be produced in a format that is capable of being queried (e.g., by owner or operator identity, by FBO identity, by aircraft model, etc.). Such a searchable format may be implemented using XML, as a searchable database, using metadata, etc. Additionally, as described above, in alternative embodiments, market share data may be aggregated over a plurality of airports within a region. This may be accomplished simply by pooling FBO visit data recorded at the plurality of airports into a single data set.

Following step 350, the method 300 terminates. However, as described above, market share data may be provided in a variety of manners, such as periodically on a monthly basis; thus, it will be apparent to those of skill in the art that performance of the method 300 may be triggered periodically and/or automatically whenever appropriate for the needs of the operator of the system 200 (e.g., in some embodiments, according to an agreement they may have in place with the operator of one of the FBOs 140, 150 or 160). It will be further apparent to those of skill in the art that, while the data analysis of steps 330-350 may be performed periodically or on an on-demand basis, an airport (e.g., airport 100) may have various aircraft (e.g., aircraft 170) arriving and departing, whether according to a predetermined schedule or on an ad hoc basis, on any given day throughout any given time period that might be the subject of market share analysis. Thus, the actions described above with respect to step 310 of method 300 may not be performed as a single discrete “step,” but, rather, may be performed on a continual basis at any time one or more aircraft are on the premises of the airport (e.g., airport 100) being monitored.

The exemplary embodiments described above with reference to FIGS. 1-3 may generate market share data for a plurality of FBOs at an airport, or at a plurality of airports within a region. The FBO market share data generated by means of the exemplary embodiments may be useful to the operator of an FBO for the same reasons that market share data will be known by those of skill in the art to be useful to any other type of business. For example, an FBO operator may provide targeted marketing to specific aircraft operators or classes of operators that have been visiting other FBOs, or may modify prices to attract a specific type of customer that has been visiting other FBOs. In addition to the above, there may be any number of other applications for the FBO market share data provided by the exemplary embodiments; however, the specific applications of the market share data are beyond the scope of the exemplary embodiments, which are directed to generating the data.

Those of skill in the art will understand that the above-described exemplary embodiments may be implemented in any number of matters, including as a software module, as a combination of hardware and software, etc. For example, the exemplary method 300 may be embodied in a program stored in a non-transitory storage medium and containing lines of code that, when compiled, may be executed by a processor.

It will be apparent to those skilled in the art that various modifications may be made to the exemplary embodiments, without departing from the spirit or the scope of the invention. Thus, it is intended that the present invention cover modifications and variations of this invention provided they come within the scope of the appended claims and their equivalents.

What is claimed is:

1. A method, comprising:
detecting, for each of a plurality of aircraft during a time period, a corresponding plurality of ground positions;
generating, for each of the plurality of aircraft, a path based on the corresponding plurality of ground positions;
comparing each of the plurality of paths to each of a plurality of bounding boxes, each of the plurality of bounding boxes denoting a perimeter of a corresponding one of a plurality of fixed base operators (“FBOs”);
generating a record of an FBO visit for each crossing of one of the paths into one of the bounding boxes, the record including an identity of the aircraft corresponding to the one of the paths and an identity of the one of the FBOs corresponding to the one of the bounding boxes; and
determining market share data for each of the plurality of FBOs during the time period.

2. The method of claim 1, wherein the plurality of ground positions are detected by multilateration.

3. The method of claim 2, wherein the multilateration is accomplished using data received from FAA Airport Surface Detection Equipment, Model X.

4. The method of claim 1, wherein the plurality of FBOs are one of A) disposed at a same airport, and B) disposed at a plurality of airports within a same region.

5. The method of claim 1, further comprising:
providing the market share data to an operator of one of the FBOs.

6. The method of claim 1, wherein the time period is one of A) a week, B) a month, and C) a year.

7. The method of claim 1, wherein the method is repeated at predetermined time intervals.

8. The method of claim 1, wherein the market share data includes one of aircraft identifiers, owner identifiers, operator identifiers, aircraft classes.

9. A system, comprising:
a data capture arrangement receiving, for each of a plurality of aircraft during a time period, a corresponding plurality of ground positions;
a memory storing a set of instructions; and
a processor executing the set of instructions to perform operations including:
generating, for each of the plurality of aircraft, a path based on the corresponding plurality of ground positions;
comparing each of the plurality of paths to each of a plurality of bounding boxes, each of the plurality of bounding boxes denoting a perimeter of a corresponding one of a plurality of fixed base operators (“FBOs”);
generating a record of an FBO visit for each crossing of one of the paths into one of the bounding boxes, the record including an identity of the aircraft corresponding to the one of the paths and an identity of the one of the FBOs corresponding to the one of the bounding boxes; and
determining share data for each of the plurality of FBOs during the time period.

10. The system of claim 9, wherein the plurality of ground positions are detected by multilateration.

11. The system of claim 10, wherein the data capture arrangement receives the plurality of ground positions from FAA Airport Surface Detection Equipment, Model X.

12. The system of claim 9, wherein the plurality of FBOs are one of A) disposed at a same airport, and B) disposed at a plurality of airports within a same region.

13. The system of claim 9, wherein the market share data is provided to an operator of one of the FBOs.

14. The system of claim 9, wherein the time period is one of A) a week, B) a month, and C) a year.

15. The system of claim 9, wherein the processor repeats the operations at predetermined time intervals.

16. The system of claim 9, wherein the market shares for each of the plurality of FBOs include one of aircraft identifiers, owner identifiers, operator identifiers, aircraft classes.

17. A non-transitory computer-readable storage medium storing a set of instructions that are executable by a processor, the instructions, when executed by the processor, causing the processor to perform operations comprising:
detecting, for each of a plurality of aircraft during a time period, a corresponding plurality of ground positions;
generating, for each of the plurality of aircraft, a path based on the corresponding plurality of ground positions;
comparing each of the plurality of paths to each of a plurality of bounding boxes, each of the plurality of bounding boxes denoting a perimeter of a corresponding one of a plurality of fixed base operators (“FBOs”);
generating a record of an FBO visit for each crossing of one of the paths into one of the bounding boxes, the record including an identity of the aircraft corresponding to the one of the paths and an identity of the one of the FBOs corresponding to the one of the bounding boxes; and
determining market share data for each of the plurality of FBOs during the time period.

18. The non-transitory computer-readable storage medium of claim 17, wherein the plurality of ground positions are detected by multilateration.

19. The non-transitory computer-readable storage medium of claim 18, wherein the multilateration is accomplished using data received from FAA Airport Surface Detection Equipment, Model X.

20. The non-transitory computer-readable storage medium of claim 17, wherein the operations further comprise:
providing the market share data to an operator of one of the FBOs.
